(19) United States
(12) Patent Application Publication
(10) Pub. No.: US 2020/0269986 A1
(43) Pub. Date: Aug. 27, 2020

(54) AIR CONDITIONING PIPING STRUCTURE FOR AIRCRAFT AND AIR CONDITIONING SYSTEM

(71) Applicant: Mitsubishi Aircraft Corporation, Aichi (JP)

(72) Inventors: Takashi Ishimaru, Tokyo (JP); Yasunari Tanaka, Aichi (JP); Satoshi Hirotsu, Tokyo (JP)

(73) Assignee: Mitsubishi Aircraft Corporation, Aichi (JP)

(21) Appl. No.: 16/794,707

(22) Filed: Feb. 19, 2020

(30) Foreign Application Priority Data
Feb. 21, 2019 (JP) 2019-029678

(51) Int. Cl. B64D 13/06

(52) U.S. Cl. CPC B64D 13/06; B64D 2013/0688; B64D 2013/0618

(57) ABSTRACT

To provide an air conditioning piping structure for an aircraft which can promote mixing of temperature adjusted air and recirculated air flowing into a mixing chamber forming an air conditioning system. An air conditioning piping structure causes temperature adjusted air obtained by an air conditioning apparatus of an aircraft and recirculated air discharged from a pressurized compartment to flow into a mixing chamber which mixes the temperature adjusted air and the recirculated air. This air conditioning piping structure includes a first pipe through which the temperature adjusted air flows, a second pipe through which the recirculated air flows, and which is connected to the first pipe, and a flow passage restricting part configured to apply a resistance to at least one of the temperature adjusted air and the recirculated air in a vicinity of a merging position where the temperature adjusted air and the recirculated air are merged.

### BACKGROUND OF THE INVENTION

### Field of the Invention

The present invention relates to an air conditioning piping structure for an aircraft, and an air conditioning system having the air conditioning piping structure for an aircraft.

### Description of the Related Art

In general, an air conditioning system with which an aircraft is equipped includes: air conditioning apparatuses each of which control a flow rate and a temperature using bleed air from an engine and outside air, thus obtaining temperature adjusted air; a mixing chamber which mixes the temperature adjusted air and recirculated air; a supply system which supplies the conditioned air obtained by the mixing chamber to pressurized compartments, such as the cabin and the cockpit; and a recirculation system which causes air discharged from the pressurized compartments to recirculate.

The mixing chamber receives and mixes temperature adjusted air from the air conditioning apparatus, and recirculated air from the recirculation system, the recirculated air usually having a higher temperature than the temperature adjusted air.

The air conditioning apparatus is provided in each of the starboard side and the port side of an aircraft. The temperature adjusted air flows into the mixing chamber trough a right pipe from a starboard air conditioning apparatus, and the temperature adjusted air flows into the same mixing chamber through a left pipe also from a port air conditioning apparatus. Recirculated air also flows into the same mixing chamber through each of the right pipe and the left pipe.

The temperature adjusted air and the recirculated air which flow into the mixing chamber respectively from each of the starboard side and the port side are mixed in the mixing chamber so that pressurized compartments can obtain conditioned air having an appropriate temperature. The conditioned air which flows out from a plurality of respective outlets of the mixing chamber is fed to the cabin and the like.

A mixer for an air conditioning apparatus disclosed in JP2007-505786W has a double structure which includes a first pipe, and a second pipe which has a larger diameter than the first pipe, and which surrounds a portion of the first pipe. The inside of the first pipe and the inside of the second pipe communicate with each other through a plurality of holes formed in the wall of the first pipe. Accordingly, temperature adjusted air which flows into the first pipe and recirculated air which flows into the second pipe are mixed in the mixer.

### SUMMARY OF THE INVENTION

In order to promote mixing of temperature adjusted air and recirculated air, it is preferable to cause temperature adjusted air and recirculated air to be merged upstream of a chamber on each of the starboard side and the port side. In such a case, merged air on the starboard side flows into the starboard inlet of the chamber, and merged air on the port side flows into the port inlet of the chamber. On each of the starboard side and the port side, temperature adjusted air and recirculated air are mixed in advance during flowing to the inlet of the chamber after the temperature adjusted air and the recirculated air are merged. Accordingly, it is possible to obtain an advantageous effect of promoting mixing in the chamber.

From the viewpoint of making the temperatures of air flowing out from the chamber uniform among the plurality of outlets by sufficiently mixing temperature adjusted air and recirculated air, it is preferable that a zone where temperature adjusted air and recirculated air flow into the inlet of the chamber after the temperature adjusted air and the recirculated air are merged have a long length. However, there may be a case where it is difficult for the zone to have a long length due to restrictions on routing of the pipes.

It is an object of the present invention to provide an air conditioning piping structure for an aircraft which can promote mixing of temperature adjusted air and recirculated air flowing into a mixing chamber forming an air conditioning system, and to provide an air conditioning system having the air conditioning piping structure for an aircraft.

A first air conditioning piping structure of the present invention causes temperature adjusted air obtained by an air conditioning apparatus of an aircraft and recirculated air discharged from a region to which the temperature adjusted air is supplied to flow into a mixing chamber which mixes the temperature adjusted air and the recirculated air.

Such an air conditioning piping structure includes a first pipe through which the temperature adjusted air flows; a second pipe through which the recirculated air flows, and which is connected to the first pipe; and a flow passage restricting part configured to apply a resistance to at least one of the temperature adjusted air and the recirculated air at a position in a vicinity of a merging position where the temperature adjusted air and the recirculated air are merged.

A second air conditioning piping structure of the present invention causes temperature adjusted air obtained by an air conditioning apparatus of an aircraft and recirculated air discharged from a region to which the temperature adjusted air is supplied to flow into a mixing chamber which mixes the temperature adjusted air and the recirculated air.

Such an air conditioning piping structure includes: a first pipe through which the temperature adjusted air flows; a second pipe through which the recirculated air flows, and which is connected to the first pipe; and a flow passage restricting part configured to apply a resistance to a merged flow of the temperature adjusted air and the recirculated air.

In the second air conditioning piping structure of the present invention, it is preferable that a cross-sectional area of a flow passage at a position downstream of a merging position where the temperature adjusted air and the recirculated air are merged and in the vicinity of the merging position be reduced by the flow passage restricting part, and the flow passage restricting part be positioned at least on a second pipe side in cross section of the flow passage.

In each of the first and second air conditioning piping structures of the present invention, it is preferable that the flow passage restricting part be formed into an annular shape or a cylindrical shape along a circumferential direction of a cross section of a flow passage at a position in the vicinity of the merging position where the temperature adjusted air and the recirculated air are merged or downstream of the merging position.

It is preferable that each of the first and second air conditioning piping structures of the present invention include: a right first pipe forming the first pipe through which the temperature adjusted air obtained by an air conditioning apparatus which corresponds to a starboard side flows; a right second pipe forming the second pipe through which the recirculated air flows toward a position where the recirculated air is merged with the temperature adjusted air flowing through the right first pipe; a left first pipe forming the first pipe through which the temperature adjusted air obtained by an air conditioning apparatus which corresponds to a port side flows; and a left second pipe forming the second pipe through which the recirculated air flows toward a position where the recirculated air is merged with the temperature adjusted air flowing through the left first pipe, wherein the mixing chamber includes: a right inlet which causes the temperature adjusted air and the recirculated air which respectively flow through the right first pipe and the right second pipe and are merged to flow into the mixing chamber; and a left inlet which causes the temperature adjusted air and the recirculated air which respectively flow through the left first pipe and the left second pipe and are merged to flow into the mixing chamber from a side opposite to the right inlet, and the flow passage restricting part is provided with respect to at least one of merging of the temperature adjusted air and the recirculated air on a right side and merging of the temperature adjusted air and the recirculated air on a left side.

A third air conditioning piping structure of the present invention causes temperature adjusted air obtained by an air conditioning apparatus of an aircraft and recirculated air discharged from a region to which the temperature adjusted air is supplied to flow into a mixing chamber which mixes the temperature adjusted air and the recirculated air.

Such an air conditioning piping structure includes: a first pipe through which the temperature adjusted air flows; a second pipe through which the recirculated air flows, and which is connected to the first pipe; and a guide part configured to guide the recirculated air toward an upstream side of the temperature adjusted air flowing through the first pipe.

In the third air conditioning piping structure of the present invention, it is preferable that, at a position where the temperature adjusted air and the recirculated air are merged, an angle formed by a flow of the temperature adjusted air and a flow of the recirculated air be an acute angle or a right angle.

In the third air conditioning piping structure of the present invention, it is preferable that the second pipe be formed into a shape which includes the guide part.

It is preferable that the third air conditioning piping structure of the present invention include: a right first pipe forming the first pipe through which the temperature adjusted air obtained by an air conditioning apparatus which corresponds to a starboard side flows; a right second pipe forming the second pipe through which the recirculated air flows toward a position where the recirculated air is merged with the temperature adjusted air flowing through the right first pipe; a left first pipe forming the first pipe through which the temperature adjusted air obtained by an air conditioning apparatus which corresponds to a port side flows; and a left second pipe forming the second pipe through which the recirculated air flows toward a position where the recirculated air is merged with the temperature adjusted air flowing through the left first pipe, wherein the mixing chamber includes: a right inlet which causes the temperature adjusted air and the recirculated air which respectively flow through the right first pipe and the right second pipe and are merged to flow into the mixing chamber; and a left inlet which causes the temperature adjusted air and the recirculated air which respectively flow through the left first pipe and the left second pipe and are merged to flow into the mixing chamber from a side opposite to the right inlet, and the guide part is provided with respect to at least one of merging of the temperature adjusted air and the recirculated air on a right side and merging of the temperature adjusted air and the recirculated air on a left side.

It is preferable that each of the first to third air conditioning piping structures of the present invention include a premixing zone where the temperature adjusted air and the recirculated air are merged, and flow into the mixing chamber.

It is also preferable that the premixing zone extend along an axis of the first pipe.

It is preferable that each of the first to third air conditioning piping structures of the present invention include the mixing chamber.

It is preferable that each of the first to third air conditioning piping structures of the present invention include: a right first pipe forming the first pipe through which the temperature adjusted air obtained by an air conditioning apparatus which corresponds to a starboard side flows; a right second pipe forming the second pipe through which the recirculated air flows toward a position where the recirculated air is merged with the temperature adjusted air flowing through the right first pipe; a left first pipe forming the first pipe through which the temperature adjusted air obtained by an air conditioning apparatus which corresponds to a port side flows; and a left second pipe forming the second pipe through which the recirculated air flows toward a position where the recirculated air is merged with the temperature adjusted air flowing through the left first pipe, wherein the mixing chamber includes: a right inlet which causes the temperature adjusted air and the recirculated air which respectively flow through the right first pipe and the right second pipe and are merged to flow into the mixing chamber; a left inlet which causes the temperature adjusted air and the recirculated air which respectively flow through the left first pipe and the left second pipe and are merged to flow into the mixing chamber from a side opposite to the right inlet; a right premixing zone which extends to the right inlet from a position where the temperature adjusted air and the recirculated air which respectively flow through the right first pipe and the right second pipe are merged; and a left premixing zone which extends to the left inlet from a position where the temperature adjusted air and the recirculated air which respectively flow through the left first pipe and the left second pipe are merged; and a length of the right premixing zone and a length of the left premixing zone differ from each other.

In the above-mentioned configuration, it is preferable that a constitutional element for promoting mixing which is selected from the flow passage restricting part and the guide part be provided with respect to at least one of merging of the temperature adjusted air and the recirculated air on a right side and merging of the temperature adjusted air and the recirculated air on a left side.

An air conditioning system of an aircraft of the present invention includes: the above-mentioned air conditioning piping structure; the air conditioning apparatus configured to obtain the temperature adjusted air using bleed air and outside air; a supply system configured to supply conditioned air which passes through the mixing chamber to the air-conditioned compartment; and a recirculation system where the recirculated air discharged from the air-conditioned compartment flows.

According to the present invention, it is possible to promote mixing of temperature adjusted air and recirculated air at a position upstream of the mixing chamber by the flow passage restricting part which is positioned in the vicinity of the merging position or downstream of the merging position, or by the guide part which guides the recirculated air toward the upstream side of the temperature adjusted air.

Mixing of temperature adjusted air and recirculated air are promoted at a position upstream of the mixing chamber so that the temperature adjusted air and the recirculated air are more sufficiently mixed in the mixing chamber. Accordingly, it is possible to make the temperature of conditioned air flowing out from respective outlets of the mixing chamber uniform.

### BRIEF DESCRIPTION OF THE SEVERAL VIEWS OF THE DRAWINGS

FIG. 1 is a view showing a configuration of an air-conditioning circuit provided in an air conditioning system with which an aircraft is equipped;

FIG. 2 is a view showing an air conditioning piping structure which includes a mixing chamber (mixing part) shown in FIG. 1;

FIG. 3 is a view showing the mixing chamber and pipes as viewed from a direction indicated by an arrow IIIb in FIG. 2;

FIG. 4A and FIG. 4B are views each showing the air conditioning piping structure according to a first embodiment, FIG. 4A being a view schematically showing the piping structure which causes air of four systems to flow into the mixing chamber, and FIG. 4B being a sectional view taken along a line IVb-IVb of FIG. 4A and FIG. 5, and showing a flow passage restricting part, and FIG. 4C is a view showing a modification of the flow passage restricting part;

FIG. 5 is a schematic view showing an area in the vicinity of a position where temperature adjusted air and recirculated air are merged;

FIG. 6 is a view showing, based on analysis results, a temperature distribution image on a section of a flow passage immediately after temperature adjusted air and recirculated air are merged;

FIG. 7A is a view showing, based on the analysis results, a temperature distribution image of a plurality of respective outlets of the mixing chamber in the first embodiment, and FIG. 7B is a view showing a comparison example;

FIG. 8A is a schematic view showing the air conditioning piping structure according to a modification of the first embodiment, FIG. 8B is a sectional view taken along a line VIIIb-VIIIb of FIG. 8A, and FIG. 8C is a view showing a modification of the flow passage restricting part;

FIG. 9 is a graph showing the relationship between an aperture ratio Ar of the flow passage in the flow passage restricting part, the maximum temperature difference ΔTmax of conditioned air flowing out toward a supply destination from the mixing chamber or an area in the vicinity of the mixing chamber, and a pressure loss ΔPt;

FIG. 10A and FIG. 10B are views each showing an example where the flow passage restricting part is provided in a first pipe, and FIG. 10C is a view showing an example where the flow passage restricting part is provided in a second pipe;

FIG. 11 is a schematic view showing an air conditioning piping structure according to a second embodiment; and

FIG. 12A is a schematic view showing a state where recirculated air is merged to temperature adjusted air at an acute angle due to the shape of a second pipe shown in FIG. 11, FIG. 12B is a schematic view showing a modification of the second embodiment, and FIG. 12C is a schematic view showing another modification of the second embodiment.

### DETAILED DESCRIPTION OF THE PREFERRED EMBODIMENTS

Hereinafter, an air conditioning piping structure for an aircraft according to embodiments of the present invention will be described with reference to attached drawings.

### (Configuration of Air Conditioning System)

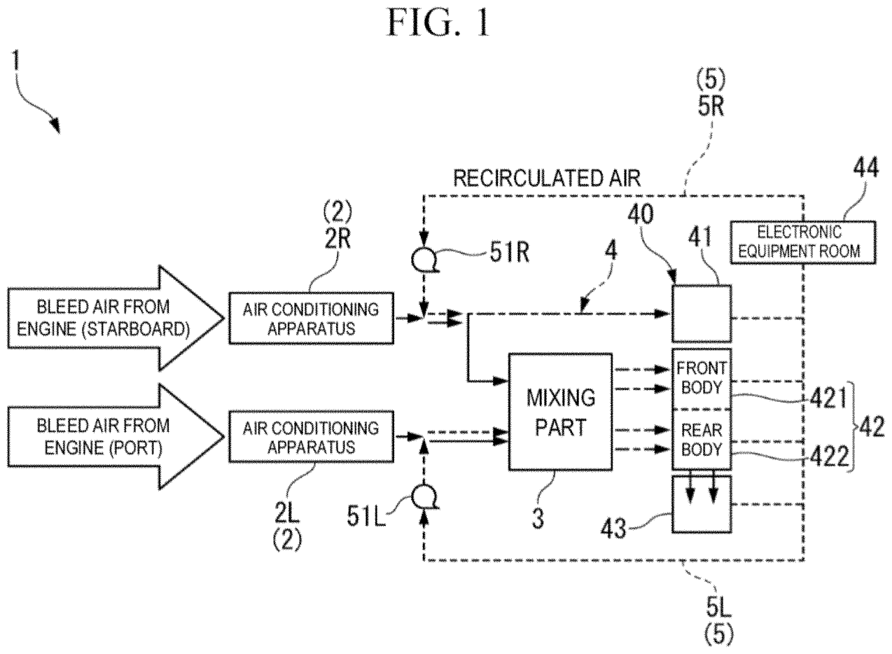

First, the schematic configuration of an entire air conditioning system 1 with which an aircraft is equipped will be described with reference to FIG. 1. The following description of the air conditioning system 1 is common to respective embodiments of the present invention.

The air conditioning system 1 (FIG. 1) performs pressurization, cooling/heating, and ventilation of a pressurized compartment 40 using bleed air extracted from an engine or an Auxiliary Power Unit (APU) and outside air (ram air) taken into the aircraft from the outside of the aircraft. The illustration of the engine and the Auxiliary Power Unit is omitted from the drawings.

The air conditioning system 1 includes air conditioning apparatuses 2 which obtain temperature adjusted air from bleed air and outside air, a mixing chamber 3 (mixing part), a supply system 4, and recirculation systems 5.

The air conditioning apparatus 2 is referred to as an Environmental control system (ECS).

In the air conditioning system 1, in order to lower fuel consumption of the aircraft, recirculated air, which is exhaust air from the pressurized compartment 40, is mixed into fresh temperature adjusted air obtained by the air conditioning apparatuses 2, and the mixture is supplied to the pressurized compartment 40.

The air conditioning apparatus 2 cools bleed air using outside air, thus obtaining temperature adjusted air. This temperature adjusted air is mixed with recirculated air by the mixing chamber 3 so that the pressurized compartment 40 can obtain conditioned air having an appropriate temperature.

The air conditioning apparatus 2 includes a compressor, a turbine, a heat exchanger, a flow rate valve, a dehumidifier and the like, for example, and controls the flow rate, the temperature and the like of temperature adjusted air. For example, the air conditioning apparatus 2 performs feedback control of the temperature in the pressurized compartment 40, thus controlling the flow rate and the temperature of temperature adjusted air.

Assume that “temperature adjusted air” refers to air which is controlled by the air conditioning apparatus 2 to a predetermined temperature using bleed air and outside air.

The air conditioning apparatus 2 (2R) which corresponds to a starboard side obtains temperature adjusted air using bleed air from the starboard engine and outside air. The air conditioning apparatus 2 (2L) which corresponds to a port side obtains temperature adjusted air using bleed air from the port engine and outside air. Both of the air conditioning apparatuses 2R, 2L use bleed air from the Auxiliary Power Unit while parked in place of bleed air from the engine.

Temperature adjusted air obtained by the starboard air conditioning apparatus 2R, temperature adjusted air obtained by the port air conditioning apparatus 2L, recirculated air flowing through the starboard recirculation system 5 (5R), and recirculated air flowing through the port recirculation system 5 (5L) are mixed in the mixing chamber 3.

The temperature adjusted air obtained by the air conditioning apparatus 2 and the recirculated air, which is air already supplied to the pressurized compartment 40 and circulated through the compartment, flows into the mixing chamber 3 at a flow rate ratio of 1:1, for example, and are mixed in the mixing chamber 3. Usually, the temperature of recirculated air is higher than the temperature of temperature adjusted air. A temperature difference between the temperature adjusted air and the recirculated air is 40 to 60° C., for example.

The conditioned air which has an appropriate temperature and which passes through the mixing chamber 3 is supplied to the pressurized compartment 40 through the supply system 4.

In FIG. 1, temperature adjusted air is indicated by solid line arrows, recirculated air is indicated by broken line arrows, and conditioned air is indicated by chain line arrows.

In the embodiment shown in FIG. 1, referring to only a cockpit 41 of a plurality of pressurized compartments (41 to 43), a part of a flow of mixture of temperature adjusted air and recirculated air is directly supplied to the cockpit 41 as conditioned air without passing through the mixing chamber 3 at a position downstream of a position where the temperature adjusted air and the recirculated air are merged. However, conditioned air which passes through the mixing chamber 3 may be supplied to the cockpit 41.

The pressurized compartment 40 includes the cockpit 41 (cockpit), a cabin 42 (cabin), and a cargo-compartment 43 (cargo). The cabin 42 is divided into a front region 421, which corresponds to a front body, and a rear region 422, which corresponds to a rear body. The supply system 4 supplies conditioned air to each of the front region 421 and the rear region 422.

In the embodiment shown in FIG. 1, conditioned air supplied to the cabin 42 is supplied to the cargo-compartment 43.

The supply system 4 typically supplies conditioned air to the respective regions 41, 421, 422, 43 from respective blow-out ports on the starboard side and the port side. The supplied conditioned air circulated in the region is discharged to an underfloor space from discharge ports disposed near floor of the respective regions 41, 421, 422, 43, for example. A part (approximately ½, for example) of air under floor is suctioned by recirculation blowers 51R, 51L to the respective recirculation systems 5R, 5L, and the remaining air is discharged to a non-pressurized compartment via a pressure regulating valve (outflow valve) not shown in the drawing. In the embodiment shown in FIG. 1, recirculated air flowing through the recirculation system 5R is also used for cooling electronic equipment disposed in an electronic equipment room 44.

### (Configuration of Air Conditioning Piping Structure)

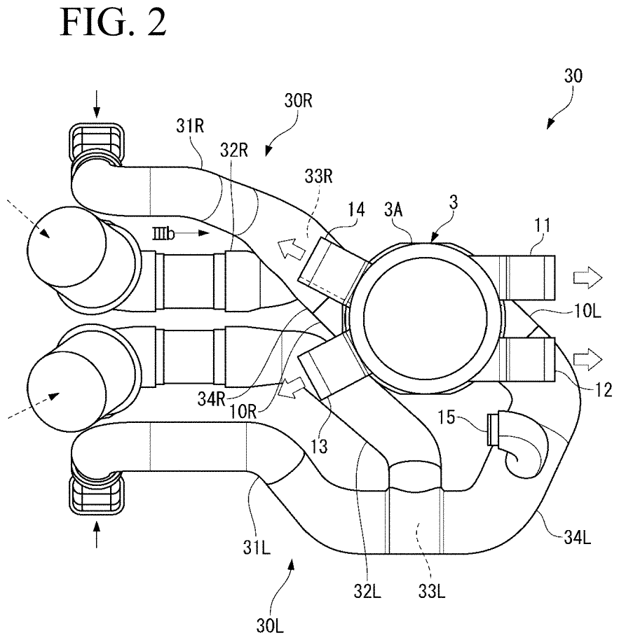

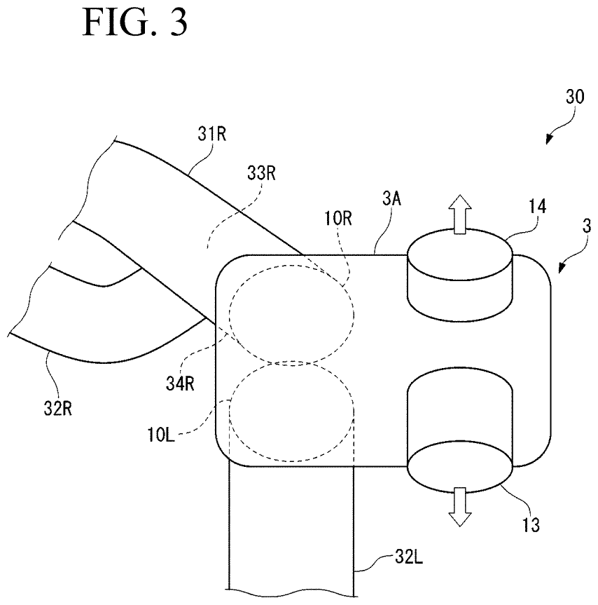

Next, an air conditioning piping structure 30 according to the embodiment of the present invention will be described with reference to FIG. 2 and FIG. 3.

The configuration of the air conditioning piping structure 30 described hereinafter is common to the respective embodiments of the present invention except for constitutional elements for promoting mixing described later.

The air conditioning piping structure 30 includes a starboard inflow pipe 30R which corresponds to the air conditioning apparatus 2R and the recirculation system 5R, a port inflow pipe 30L which corresponds to the air conditioning apparatus 2L and the recirculation system 5L, and the mixing chamber 3 into which temperature adjusted air and recirculated air flow respectively through the inflow pipes 30R, 30L.

As shown in FIG. 2 and FIG. 3, the mixing chamber 3 is formed into a substantially cylindrical shape, and includes two inlets 10R, 10L, and a plurality of (four in this embodiment) outlets 11 to 14. All of these inlets 10R, 10L and outlets 11 to 14 are provided in a substantially cylindrical chamber body 3A of the mixing chamber 3.

Outflow pipes not shown in the drawing are respectively connected to the outlets 11 to 14. The outlets 11 to 14 individually correspond to the blow-out port on the starboard side in the cabin front region 421, the blow-out port on the port side in the cabin front region 421, the blow-out port on the starboard side in the cabin rear region 422, and the blow-out port on the port side in the cabin rear region 422.

Unlike this embodiment, five outlets including an outlet for supplying air to the cockpit may be provided in the mixing chamber 3.

The starboard inflow pipe 30R causes temperature adjusted air and recirculated air to flow into the chamber body 3A from the inlet 10R.

The port inflow pipe 30L causes temperature adjusted air and recirculated air to flow into the chamber body 3A from the inlet 10L, which is positioned on the side opposite to the inlet 10R.

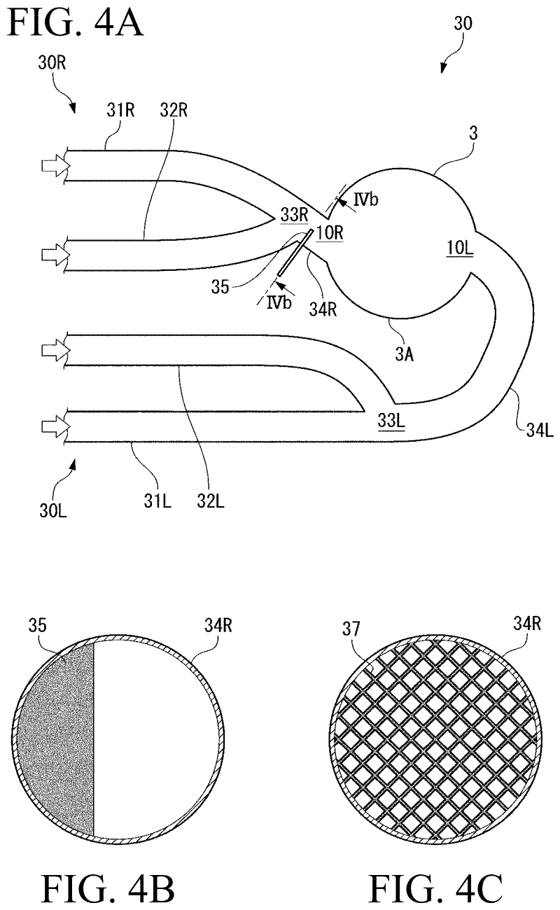

As shown in FIG. 3, the inlets 10R, 10L are positioned on one end side in the axial direction of the chamber body 3A. As shown in FIG. 2 (see also FIG. 4A), the inlet 10R and the inlet 10L are disposed in substantially point symmetry with respect to the axis of the chamber body 3A, and both of the inlet 10R and the inlet 10L are open to the inside of the chamber body 3A along the tangential direction of the chamber body 3A.

The outlets 11 to 14 distribute in the circumferential direction of the chamber body 3A on the other end side in the axial direction of the chamber body 3A.

The diameter and the length in the axial direction of the chamber body 3A are appropriately set such that the inlets 10R, 10L and the outlets 11 to 14 can be arranged without interference between the respective openings of the inlets 10R, 10L and the outlets 11 to 14.

Temperature adjusted air and recirculated air which flow into the chamber body 3A in the tangential direction of the chamber body 3A from each of the inlet 10R and the inlet 10L are mixed while forming a swirling flow in the chamber body 3A, and the mixture flows out to outflow pipes not shown in the drawing from the outlets 11 to 14.

The starboard inflow pipe 30R includes a first pipe 31R through which temperature adjusted air obtained by the air conditioning apparatus 2R flows, and a second pipe 32R through which recirculated air flows, and which is connected to the first pipe 31R at a position upstream of the mixing chamber 3. The second pipe 32R forms a portion of the recirculation system 5R.

Temperature adjusted air and recirculated air are merged at a portion where the first pipe 31R and the second pipe 32R are connected with each other (see FIG. 3).

The first pipe 31R and the second pipe 32R are connected with each other at the position upstream of the mixing chamber 3 and hence, temperature adjusted air and recirculated air are merged upstream of the mixing chamber 3 and, thereafter, flow into the inlet 10R and flow into the mixing chamber 3.

In the same manner, the port inflow pipe 30L includes a first pipe 31L through which temperature adjusted air obtained by the air conditioning apparatus 2L flows, and a second pipe 32L through which recirculated air flows, and which is connected to the first pipe 31L at a position upstream of the mixing chamber 3. The second pipe 32L forms a portion of the recirculation system 5L.

The first pipe 31L and the second pipe 32L are connected with each other at the position upstream of the mixing chamber 3 and hence, temperature adjusted air and recirculated air are merged upstream of the mixing chamber 3 and, thereafter, flow into the inlet 10L and flow into the mixing chamber 3.

In each of the inflow pipes 30R, 30L, temperature adjusted air and recirculated air are mixed in advance during flowing to the mixing chamber 3 after the temperature adjusted air and the recirculated air are merged. Accordingly, compared with the case where temperature adjusted air and recirculated air separately flow into the mixing chamber 3 without being merged, temperature adjusted air and recirculated air are mixed more sufficiently in the mixing chamber 3 before the temperature adjusted air and recirculated air flow out from the outlets 11 to 14 of the mixing chamber 3. That is, temperature adjusted air and recirculated air are merged upstream of the mixing chamber 3 and hence, mixing of the temperature adjusted air and the recirculated air is promoted.

The temperature adjusted air flowing through the starboard first pipe 31R and the recirculated air flowing through the starboard second pipe 32R flow through a premixing zone 34R from a merging position (merging position 33R) to the inlet 10R of the mixing chamber 3. In the embodiment shown in FIG. 2, the premixing zone 34R corresponds to a portion of the first pipe 31R, and extends along the axis of the first pipe 31R.

The temperature adjusted air flowing through the port first pipe 31L and the recirculated air flowing through the port second pipe 32L flow through a premixing zone 34L from a merging position (merging position 33L) to the inlet 10L of the mixing chamber 3. In the embodiment shown in FIG. 2, the premixing zone 34L corresponds to a portion of the first pipe 31L.

The port premixing zone 34L is longer than the starboard premixing zone 34R. Accordingly, mixing of the temperature adjusted air and the recirculated air advances during flowing through the premixing zone 34L from the merging position 33L to the inlet 10L.

An outlet 15 is provided in the side wall of the port premixing zone 34L, and a part of the flow of the mixture of the temperature adjusted air and the recirculated air flowing through the premixing zone 34L is extracted toward the cockpit 41 through the outlet 15.

Each of the pipes 31R, 32R of the inflow pipe 30R and the pipes 31L, 32L of the inflow pipe 30L is formed to have a predetermined shape and a predetermined length from a viewpoint of causing temperature adjusted air and recirculated air to be sufficiently mixed while ensuring a flow rate required for each of the temperature adjusted air and the recirculated air.

Another viewpoint may be to allow a structure including the mixing chamber 3, the inflow pipes 30R, 30L, and the outflow pipes not shown in the drawing connected to the respective outlets of the mixing chamber 3 to be accommodated in an installation space given in the aircraft, and to avoid interference with members disposed around the structure. Reducing the weight of an airframe by suppressing the volume of the structure is preferable also from the viewpoint of lowering fuel consumption. It is preferable to set the shape, length and the like of the respective inflow pipes 30R, 30L by also taking into such viewpoints.

In terms of efficiency of promoting mixing of temperature adjusted air and recirculated air at the time of merging, it is preferable to connect the second pipe 32R to the first pipe 31R at a right angle.

However, due to reasons such as narrow installation space, there may be a case where the second pipe 32R has no option but to be connected to the first pipe 31R in an inclined state as in the case of this embodiment (see FIG. 3).

In addition, the first pipe 31R may be connected to the second pipe 32R.

As shown in FIG. 2, respective pipes of the inflow pipes 30R, 30L are caused to route around the mixing chamber 3 orderly.

The first pipe 31R and the second pipe 32R of the starboard inflow pipe 30R extend rearward from the front side, which is the upstream side, and are integrated into one pipe at a position forward of the chamber body 3A (premixing zone 34R), and the premixing zone 34R is connected to the inlet 10R positioned on the front side of the chamber body 3A.

The first pipe 31L and the second pipe 32L of the port inflow pipe 30L extend rearward from the front side, which is the upstream side, and are integrated into one pipe on the lateral side of the chamber body 3A (premixing zone 34L). The premixing zone 34L is routed to an area behind the chamber body 3A, and is connected to the inlet 10L, which is positioned on the rear side of the chamber body 3A.

The description will be made hereinafter with respect to constitutional elements for further promoting mixing of temperature adjusted air and recirculated air in the air conditioning piping structure 30 where the temperature adjusted air and the recirculated air are merged upstream of the mixing chamber 3 as described above.

### First Embodiment

An air conditioning piping structure 30 according to a first embodiment will be described with reference to FIG. 4A to FIG. 9 in addition to FIG. 1 to FIG. 3.

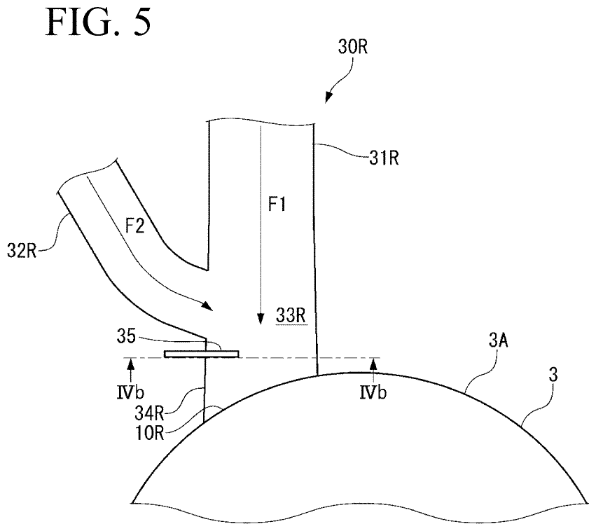

As shown in FIG. 4A and FIG. 5, the air conditioning piping structure 30 of the first embodiment is mainly characterized by including a flow passage restricting part 35 which applies a resistance to at least one of temperature adjusted air flowing through a starboard first pipe 31R and recirculated air flowing through the starboard second pipe 32R at a position in the vicinity of a merging position 33R where the temperature adjusted air and the recirculated air are merged. The flow passage restricting part 35 is a member which applies a resistance to a fluid by partially restricting the flow passage in the pipe, and the flow passage restricting part 35 corresponds to a constitutional element for promoting mixing of temperature adjusted air and recirculated air.

In FIG. 5, the flow of temperature adjusted air is indicated by an arrow F1, and the flow of recirculated air is indicated by an arrow F2. The extension of the arrow F1 and the extension of the arrow F2 intersect with each other. The point of intersection between the extension of the arrow F1 and the extension of the arrow F2 and an area in the vicinity of the point of intersection correspond to a merging position 33R.

As shown in FIG. 2 and FIG. 4A, the length of a premixing zone 34R of a starboard inflow pipe 30R is shorter than the length of a premixing zone 34L of a port inflow pipe 30L. Accordingly, the flow passage restricting part 35 is provided in the premixing zone 34R on the starboard side where, only in terms of a difference in length between the premixing zones 34R, 34L, a mixing promoting effect obtained by merging is smaller. With such a configuration, mixing of temperature adjusted air and recirculated air is sufficiently promoted even with the shorter premixing zone 34R.

On the contrary to this embodiment, there may be a case where the port premixing zone 34L is shorter than the starboard premixing zone 34R due to the routing passage of the inflow pipes 30R, 30L. In such a case, it is preferable to provide the flow passage restricting part 35 at a position in the vicinity of the port merging position 33L.

As shown in FIG. 4A and FIG. 5, the flow passage restricting part 35 is disposed on the second pipe 32R side at a position downstream of the merging position 33R and in the vicinity of the merging position 33R. With the flow passage restricting part 35, a resistance is mainly applied to recirculated air, thus promoting mixing.

With the installation of the flow passage restricting part 35, the cross-sectional area of the flow passage in the premixing zone 34R is reduced by an amount corresponding to the area of the region of the flow passage restricting part 35 shown in gray in FIG. 4B. That is, the flow passage restricting part 35 is disposed inside the pipe in the premixing zone 34R so that the flow passage in the premixing zone 34R is narrowed. The area of a white region inside the pipe having a circular shape in cross section in the premixing zone 34R shown in FIG. 4B corresponds to the cross-sectional area of the flow passage in the premixing zone 34R.

The shape in cross section of each pipe, such as the first pipe 31R, the second pipe 32R, and the premixing zone 34R, is not limited to a circular shape, and may be an appropriate shape, such as an elliptical shape or a rectangular shape.

The flow passage restricting part 35 may be formed into an appropriate shape provided that the flow passage restricting part 35 can apply a resistance to at least one of temperature adjusted air and recirculated air at a position in the vicinity of the merging position 33R.

The flow passage restricting part 35 may have a plate shape as shown in FIG. 4A and FIG. 5, for example.

In the embodiment shown in FIG. 5, the flow passage restricting part 35 is orthogonal to the pipe axis of the premixing zone 34R. However, the flow passage restricting part 35 may be inclined with respect to the pipe axis.

The flow passage restricting part 35 may be mounted on the pipe in the premixing zone 34R as in the case of this embodiment. Alternatively, the flow passage restricting part 35 may be integrally formed with the pipe in the premixing zone 34R.

As shown in FIG. 4B and FIG. 5, the flow passage restricting part 35 in this embodiment is positioned on the second pipe 32R side as viewed in cross section of the flow passage in the premixing zone 34R. This flow passage restricting part 35 is installed, by an appropriate method, to the pipe at a position near the flow of recirculated air which flows out from the second pipe 32R.

This flow passage restricting part 35 applies a flow resistance mainly to the flow of recirculated air of temperature adjusted air and recirculated air at a position downstream of the merging position 33R. With the installation of the flow passage restricting part 35, a resistance is applied. However, the necessary pressure and flow rate of each of the temperature adjusted air and the recirculated air are ensured to maintain the function of the air conditioning system 1, such as cooling/heating, pressurization, and ventilation.

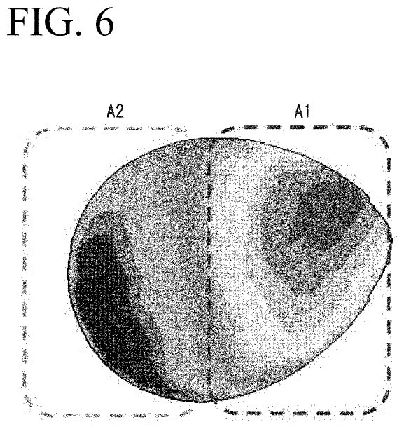

FIG. 6 shows a temperature distribution image on the cross section of the flow passage immediately after temperature adjusted air and recirculated air are merged. As shown by color shading based on temperature distribution, the inside of the pipe is divided into two sections consisting of a region A1 formed of temperature adjusted air having relatively low temperature and a region A2 formed of recirculated air having relatively high temperature.

Temperature adjusted air and recirculated air are gradually mixed while transferring and receiving heat based on a density difference which corresponds to a temperature difference during flowing through the premixing zone 34R. In addition to the above, a resistance is applied to the temperature adjusted air and the recirculated air by the flow passage restricting part 35 so that a flow motion is generated in the temperature adjusted air and the recirculated air whereby the temperature adjusted air and the recirculated air are mixed. The temperature adjusted air and the recirculated air to which the flow motion is applied by the flow passage restricting part 35 are mixed while being stirred by a flow motion and transferring and receiving heat.

Even when the premixing zone 34R where temperature adjusted air and recirculated air are mixed has a small length, an appropriate resistance is applied by the flow passage restricting part 35 to the flow of the temperature adjusted air and the recirculated air merged and hence, mixing of the temperature adjusted air and the recirculated air can be sufficiently promoted before the terminal end (inlet 10R) of the premixing zone 34R.

Meanwhile, with respect to the flow of the temperature adjusted air and the recirculated air merged at the merging position 33L in the port inflow pipe 30L (FIG. 4A) having the long premixing zone 34L, the flow is divided into two sections consisting of the regions A1, A2 having different temperatures as shown in FIG. 6 immediately after merging. Even if the flow forms a laminar flow parallel to the pipe axis, mixing advances during flowing through the premixing zone 34L.

Depending on the length of the premixing zone 34L, the temperature of temperature adjusted air flowing through the first pipe 31L, the temperature of recirculated air flowing through the second pipe 32L and the like, mixing can be promoted by providing the flow passage restricting part 35 also to the port inflow pipe 30L.

The flow merged in the inflow pipe 30R and the flow merged in the inflow pipe 30L respectively flow into the mixing chamber 3 from the inlet 10R and the inlet 10L. Then, the flows are more sufficiently mixed in the mixing chamber 3 while swirling before the flows flow out from the outlets 11 to 14.

According to this embodiment, not only from the starboard inflow pipe 30R but also from the port inflow pipe 30L, a flow of the temperature adjusted air and the recirculated air merged flows into the mixing chamber 3 in a state where the flows have small temperature deviation. Accordingly, before the flows reach the outlets 11 to 14 of the mixing chamber 3, the temperature adjusted air and the recirculated air can be sufficiently mixed until the temperature adjusted air and recirculated air assume a uniform temperature.

Even if there is a temperature difference in either one or both of the temperature adjusted air and the recirculated air between the starboard inflow pipe 30R and the port inflow pipe 30L, such a temperature difference is sufficiently smaller than a temperature difference between the temperature adjusted air and the recirculated air.

That is, there may be a case where there is a variation in temperature of temperature adjusted air or in temperature of recirculated air between the inflow pipe 30R and the inflow pipe 30L. Also in such a case, a deviation in temperature is set small using the action of the flow passage restricting part 35 in the inflow pipe 30R where the premixing zone 34R disposed on the downstream of the merging position has a small length, and the temperature adjusted air and the recirculated air which flow into the mixing chamber 3 from the inflow pipes 30R, 30L are sufficiently mixed in the mixing chamber 3. Accordingly, the temperature of conditioned air flowing out from the outlets 11 to 14 of the mixing chamber 3 can be made uniform.

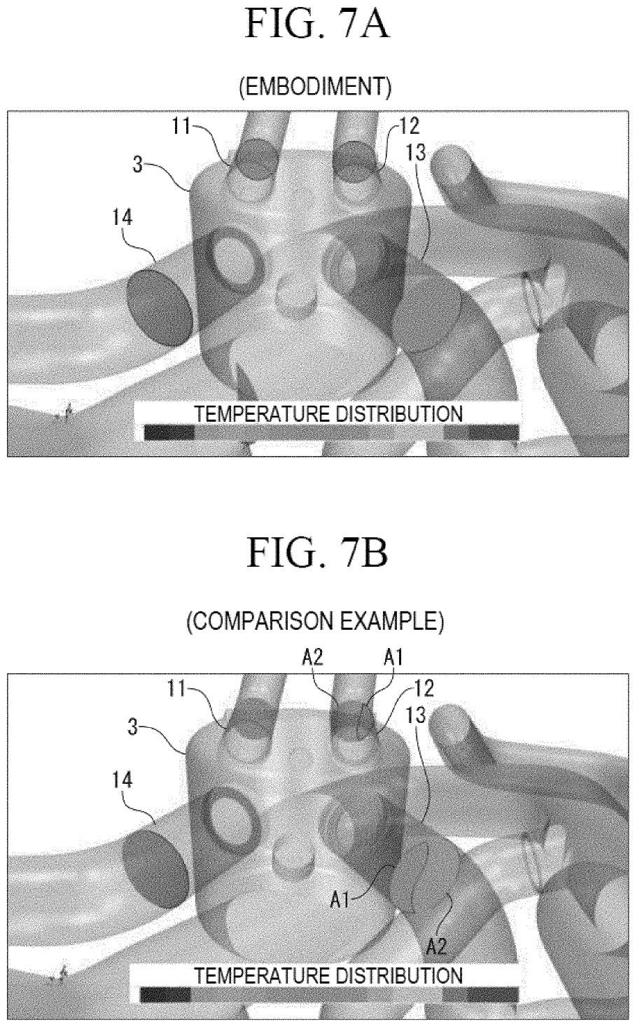

FIG. 7A shows, with color shading, the image of temperature distribution of the respective outlets 11 to 14 of the mixing chamber 3 in this embodiment which includes the flow passage restricting part 35.

FIG. 7B shows, as a comparison example, temperature distribution of the outlets 11 to 14 in the case where the flow passage restricting part 35 is not provided. The air conditioning piping structure of the comparison example is formed in substantially the same manner as the air conditioning piping structure 30 except that the flow passage restricting part 35 is not provided.

In the comparison example (FIG. 7B), a temperature difference is observed among the outlets 11 to 14. For example, the average temperature at the outlet 12 is higher than the average temperature at the outlet 13.

In this comparison example, the presence of the region A1 having a high temperature and the presence of the region A2 having a low temperature are observed in the outlet 12. The presence of a region A1 having a high temperature and the presence of a region A2 having a low temperature are also observed in the outlet 13. As described above, the flow rate ratio of temperature adjusted air to recirculated air is 1:1, for example. The flow rate ratio may vary due to temperature control performed by the air conditioning apparatus 2, external factors or the like. However, the flow rate ratio does not significantly depart from this ratio provided that control is performed within a usual range. In the comparison example, temperature adjusted air and recirculated air having substantially the same flow rate ratio flow into the mixing chamber 3 while forming a laminar flow which extends parallel to the pipe axis without being sufficiently mixed. It is considered that such flowing leads to a temperature difference among the outlets 11 to 14.

On the other hand, in this embodiment (FIG. 7A), temperature deviation in each of the outlets 11 to 14 is small, and average temperatures in the respective outlets 11 to 14 are substantially equal to each other. In this embodiment, a temperature difference of conditioned air flowing out toward a supply destination from the respective outlets 11 to 14 among the outlets 11 to 14 is smaller than that in the comparison example.

For example, in the comparison example, a difference between the maximum temperature and the minimum temperature among the outlets 11 to 14 is approximately 5° C. However, in this embodiment, a difference between the maximum temperature and the minimum temperature among the outlets 11 to 14 is only approximately 2.7° C.

A temperature difference among the outlets 11 to 14 of the mixing chamber 3 is small. Accordingly, it is possible to make the temperature of the entire room uniform, the room including the starboard side and the port side of the front region 421 of the cabin 42, and the starboard side and the port side of the rear region 422 of the cabin 42, and conditioned air being distributed to the front region 421 and the rear region 422 from the same mixing chamber 3. That is, conditioned air having an appropriate temperature can be supplied to the entire cabin 42.

If there is no unevenness of the temperature in the entire cabin 42, control of the air conditioning apparatus 2, which is performed based on the representative temperature detected at one portion or some portions of the cabin 42, is stably performed with a small fluctuation in the temperature of conditioned air while the use amount of bleed air is suppressed.

Due to the above-mentioned reasons, conditioned air whose temperature is stable at an appropriate temperature is supplied to the entire cabin 42 and hence, comfort of passengers can be enhanced. Further, control is efficiently performed by suppressing the use amount of bleed air, thus contributing to lowering of fuel consumption.

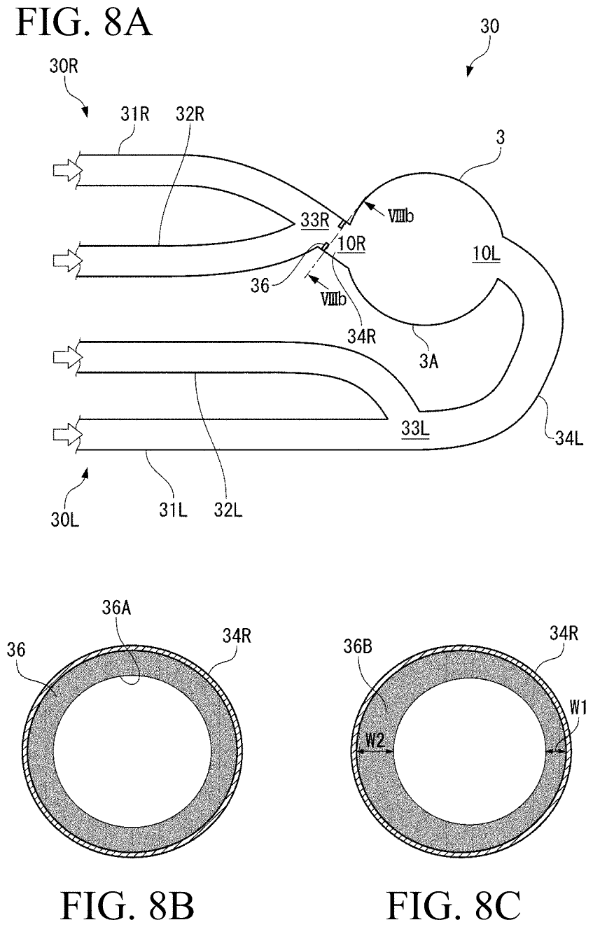

It is also possible to adopt a flow passage restricting part 36 shown in FIG. 8A and FIG. 8B in place of the flow passage restricting part 35. The flow passage restricting part 36 corresponds to a throttle which is installed between the merging position 33R and the inlet 10R. The flow passage restricting part 36 is formed into an annular shape or a cylindrical shape along the circumferential direction of the cross section of the flow passage in the premixing zone 34R. As shown in FIG. 8B, the cross-sectional area of the flow passage in the premixing zone 34R is reduced by the flow passage restricting part 36.

The flow passage restricting part 36 applies a resistance to both of temperature adjusted air and recirculated air after merging. Also with this flow passage restricting part 36, it is possible to generate a flow motion in a merged flow, thus promoting mixing.

An opening 36A of the flow passage restricting part 36 which acts as a flow passage is not limited to a shape concentric with the axis of the premixing zone 34R, and may have a shape which is eccentric with respect to the axis of the premixing zone 34R. For example, in order to apply a resistance mainly to the flow of recirculated air, a width W2 on the recirculated air side may be larger than a width W1 on the temperature adjusted air side as in the case of a flow passage restricting part 36B shown in FIG. 8C.

Besides, the flow passage restricting part may be formed into an appropriate shape provided that the flow passage restricting part can apply a resistance to the flow of the temperature adjusted air and the recirculated air merged. For example, the entire flow passage restricting part may be formed into a mesh shape as in the case of a flow passage restricting part 37 shown in FIG. 4C.

When the flow passage restricting part 35 is installed in the vicinity of the merging position 33R as in the case of this embodiment, there is no possibility that the merged flow of temperature adjusted air and recirculated air maintains a laminar flow. Immediately after the temperature adjusted air and the recirculated air are merged, the temperature adjusted air and the recirculated air generates a flow motion due to the flow passage restricting part 35, thus being mixed. Thereafter, mixing of the temperature adjusted air and the recirculated air further advances during flowing to the inlet 10R. Accordingly, there is a high mixing promoting effect.

However, the position where the flow passage restricting part 35 is disposed is not limited to a position in the vicinity of the merging position 33R. Even when the flow passage restricting part 35 is disposed at an appropriate position downstream of the merging position 33R, it is also possible to promote mixing of temperature adjusted air and recirculated air.

Depending on the length of the premixing zone 34R, it is possible to increase a mixing promoting effect by arranging the plurality of flow passage restricting parts 35 in the premixing zone 34R at intervals in the direction of the pipe axis.

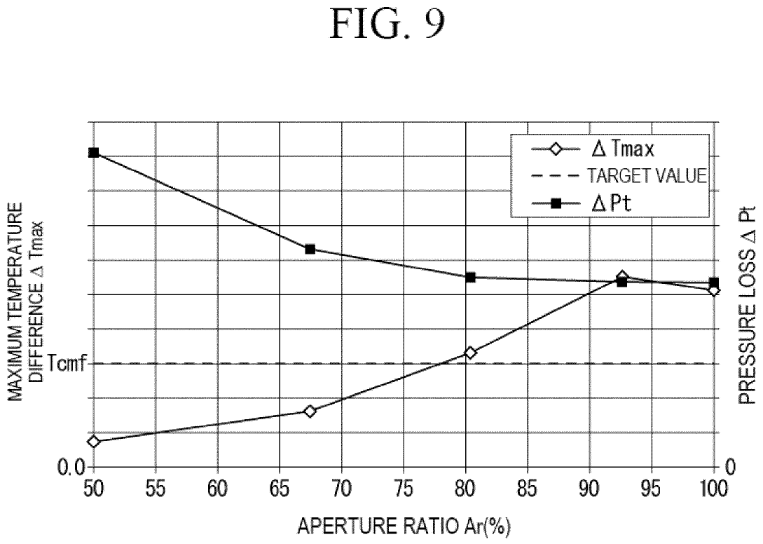

FIG. 9 shows, based on the analysis results, the relationship between an aperture ratio Ar of the flow passage at the flow passage restricting part 35 (FIG. 4A and FIG. 4B), the maximum temperature difference ΔTmax, and a pressure loss ΔPt.

Referring to FIG. 4B, the aperture ratio Ar corresponds to the ratio of the area of a gray region (flow passage restricting part 35) to the area of the entire opening of the pipe in the premixing zone 34R.

The maximum temperature difference ΔTmax corresponds to the maximum temperature difference, among the outlets 11 to 14, between average temperatures of conditioned air which respectively flows out from the outlets 11 to 14 of the mixing chamber 3. That is, the maximum temperature difference ΔTmax corresponds to a difference between the maximum value and the minimum value of the average temperature at the respective outlets. A smaller maximum temperature difference ΔTmax indicates that a temperature is made more uniform among the outlets 11 to 14. The maximum temperature difference ΔTmax can be obtained by an analysis where predetermined setting conditions are given to temperature control performed by the air conditioning apparatus 2.

A pressure loss ΔPt is shown as a reference of an index of a resistance when air flows. The pressure loss ΔPt corresponds to the amount of dropping of pressure loss of 1000 Pa, for example.

As shown in FIG. 9, the smaller the aperture ratio Ar, the smaller the maximum temperature difference ΔTmax becomes. On the other hand, the smaller the aperture ratio Ar, the larger the pressure loss ΔPt becomes. Even if the setting conditions are changed, the relationship between the aperture ratio Ar, the maximum temperature difference ΔTmax, and the pressure loss ΔPt shows a similar tendency.

As can be understood from FIG. 9, provided that the aperture ratio of the flow passage which is restricted by the flow passage restricting part 35 falls within a range from 50 to 78%, it is possible to realize the maximum temperature difference ΔTmax of an upper limit value Tcmf or less, which is a target temperature difference for satisfying comfort while the pressure loss ΔPt is suppressed by taking into account that a pressure and a flow rate necessary for maintaining the air-conditioning function are ensured. The upper limit value Tcmf indicated by a broken line in FIG. 9 is 3° C., for example.

The relationship between the aperture ratio Ar of the flow passage at the flow passage restricting part 36 shown in FIG. 8A and FIG. 8B, the maximum temperature difference ΔTmax, and the pressure loss ΔPt also shows a tendency similar to that shown in FIG. 9. Accordingly, provided that the aperture ratio of the flow passage which is restricted by the flow passage restricting part 36 falls within a range from 50 to 78%, it is possible to realize the maximum temperature difference ΔTmax of the upper limit value Tcmf or less while the pressure loss ΔPt is suppressed by taking into account that a pressure and a flow rate necessary for maintaining the air-conditioning function are ensured.

### Modification of First Embodiment

Examples of another flow passage restricting parts are shown each of which is disposed in the vicinity of the merging position 33R in the same manner as the flow passage restricting part 35 in the first embodiment.

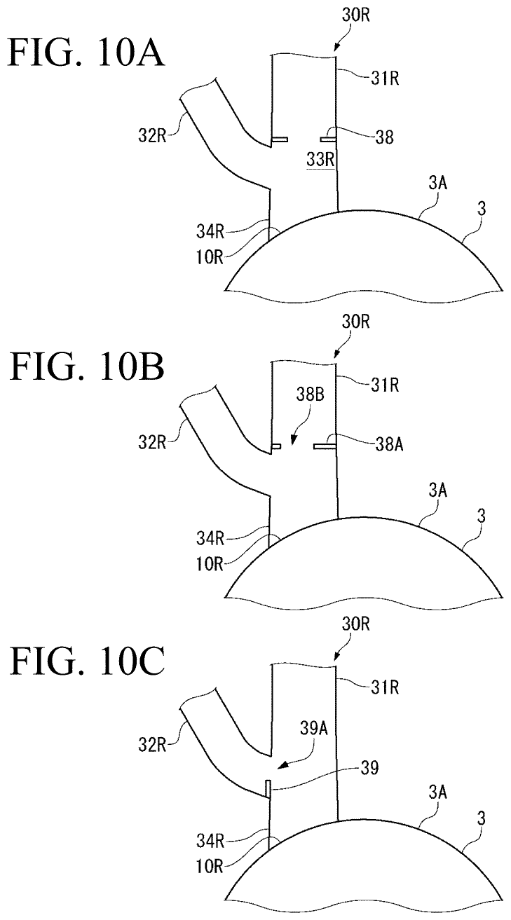

A flow passage restricting part 38 shown in FIG. 10A is disposed in the vicinity of the merging position 33R in the first pipe 31R. The flow passage restricting part 38 corresponds to a throttle which is formed in the same manner as the flow passage restricting part 36 shown in FIG. 8A and FIG. 8B.

When a resistance is applied to temperature adjusted air flowing through the first pipe 31R by the flow passage restricting part 38, a flow motion is generated also in recirculated air with which temperature adjusted air is merged in addition to in the temperature adjusted air. Accordingly, mixing of temperature adjusted air and recirculated air can be promoted.

An opening 38B which acts as a flow passage at a flow passage restricting part 38A shown in FIG. 10B is eccentric to the second pipe 32R side with respect to the axis of the first pipe 31R. With this flow passage restricting part 38A, the flow of temperature adjusted air is deflected toward the second pipe 32R and hence, a stirring effect brought about by a flow motion generated at the time of merging is increased whereby mixing of temperature adjusted air and recirculated air can be more promoted.

A flow passage restricting part 39 shown in FIG. 10C is provided in the second pipe 32R, and is positioned in the vicinity of the merging position 33R. This flow passage restricting part 39 is positioned on the downstream side of temperature adjusted air flowing through the first pipe 31R in cross section of the flow passage of the second pipe 32R.

Note that the flow passage restricting part 39 may be formed of a throttle having an annular shape in the same manner as the flow passage restricting part 38 shown in FIG. 10A.

A resistance is applied to recirculated air by the flow passage restricting part 39 so that recirculated air and temperature adjusted air are caused to generate a flow motion whereby mixing of recirculated air and temperature adjusted air can be promoted.

With the installation of the flow passage restricting part 39, the flow passage of the second pipe 32R (an opening 39A of the flow passage restricting part 39) is shifted toward the upstream side of temperature adjusted air with respect to the axis of the second pipe 32R and hence, the flow of recirculated air is deflected toward the upstream side of temperature adjusted air. Accordingly, a stirring effect brought about by a flow motion generated at the time of merging is increased so that mixing of temperature adjusted air and recirculated air can be more promoted.

### Second Embodiment

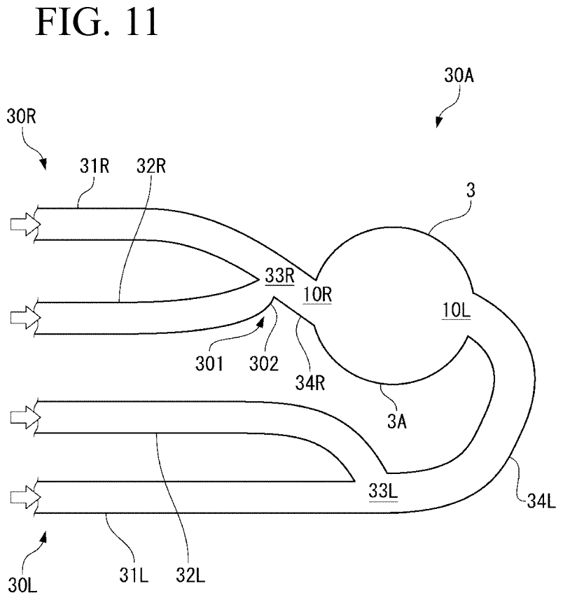

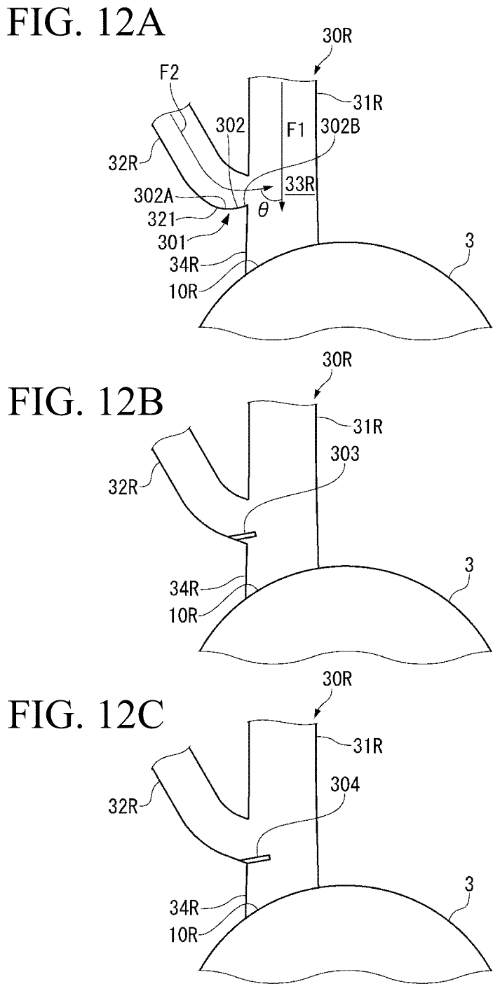

Next, an air conditioning piping structure 30A of a second embodiment will be described with reference to FIG. 11 and FIG. 12A to FIG. 12C. The air conditioning piping structure 30A includes a constitutional element which can contribute to the promotion of mixing of temperature adjusted air and recirculated air in place of the above-mentioned flow passage restricting part 35 or the like, or in combination with the flow passage restricting part 35 and the like.

Hereinafter, the description will be made mainly with respect to matters which are different from the first embodiment. The configurations substantially equal to that in the first embodiment are given the same reference symbols.

The air conditioning piping structure 30A of the second embodiment shown in FIG. 11 and FIG. 12A to FIG. 12C is characterized by including a guide part 301 which guides recirculated air toward the upstream side of temperature adjusted air. Except that the air conditioning piping structure 30A includes the guide part 301, the air conditioning piping structure 30A is formed in substantially the same manner as the air conditioning piping structure 30 of the first embodiment (FIG. 2, FIG. 4A to FIG. 4C).

The guide part 301 has an inclined surface 302 which is inclined, with respect to the axis of the second pipe 32R, in a direction along which recirculated air is guided toward the upstream side of temperature adjusted air. An end portion 302B of the inclined surface 302 on the downstream side of recirculated air is positioned more inward in the radial direction of the second pipe 32R than an end portion 302A of the inclined surface 302 on the upstream side of recirculated air. It is preferable that the inclined surface 302 is smoothly continued to the inner peripheral portion of the second pipe 32R.

With the guide part 301, the flow passage in the vicinity of the terminal end of the second pipe 32R has the cross-sectional area gradually reducing toward the terminal end while the flow passage is shifted toward the upstream side of temperature adjusted air.

It is preferable that the second pipe 32R be formed into a shape which includes the guide part 301. With such a configuration, it is possible to obtain a mixing promoting effect without adding a member to the pipe.

Alternatively, the second pipe 32R may be caused to have a shape substantially equal to the guide part 301 by mounting a guide part 303 to the second pipe 32R as shown in FIG. 12B.

The flow of recirculated air is indicated by an arrow F2 in FIG. 12A. As indicated by the arrow F2, it is possible to cause recirculated air to flow out from the second pipe 32R toward the upstream side of temperature adjusted air, flowing through the first pipe 31R in the direction indicated by an arrow F1, by the guide part 301 disposed in the vicinity of the terminal end of the second pipe 32R.

That is, by the action of the guide part 301, the flow F2 of recirculated air is deflected toward the upstream side of temperature adjusted air with respect to the axis of the second pipe 32R. With such a deflection, the angle θ formed by the flow F2 of recirculated air and the flow F1 of temperature adjusted air is small. A merging angle θ may be an obtuse angle exceeding 90°. However, it is preferable that the merging angle θ be a right angle or less (right angle or acute angle).

With a smaller merging angle θ formed by recirculated air and temperature adjusted air, it is possible to obtain a higher stirring effect brought about by the impingement of the flow F1 and the flow F2 at the time of merging. Accordingly, a laminar flow is not easily formed whereby mixing is promoted.

In addition to the above, compared with the case where a throttle having an annular shape is disposed in the vicinity of the terminal end of the second pipe 32R, the merging position 33R between temperature adjusted air and recirculated air is shifted to the upstream side of temperature adjusted air. As a result, a distance from the merging position 33R to the inlet 10R is increased. Also with such an increase, mixing of temperature adjusted air and recirculated air can be more promoted.

From a certain viewpoint, by the action of the guide part 301, it is possible to obtain a merging angle θ substantially equal to that in the case where the second pipe 32R is connected to the first pipe 31R at a right angle in a state where the radius of curvature of the second pipe 32R is reduced. That is, there may be a case where the second pipe 32R is not allowed to be connected to the first pipe 31R at a right angle due to interference with members disposed around the second pipe 32R or restrictions, such as an installation space. Even in such a case, by providing the guide part 301 to an outer peripheral side 321 of the second pipe 32R which has a large radius of curvature of a curve, the merging angle θ can approximate to a right angle and hence, it is possible to increase a mixing promoting effect.

Also with the second embodiment, it is possible to obtain a mixing promoting effect substantially equal to that in the first embodiment where the flow passage is restricted in the vicinity of the merging position 33R. Specifically, it is possible to realize the maximum temperature difference ΔTmax and the pressure loss ΔPt which correspond to the aperture ratio Ar of approximately 78% shown in FIG. 9.

Also in the second embodiment, mixing of temperature adjusted air and recirculated air is sufficiently promoted at a position upstream of the mixing chamber 3 and hence, the temperature of conditioned air flowing out from the outlets 11 to 14 of the mixing chamber 3 can be made uniform.

In addition to the above, in the second embodiment, recirculated air flows smoothly along the guide part 301 so that peeling or the like does not easily occur. Accordingly, it is possible to sufficiently obtain a mixing promoting effect while an increase in pressure loss caused by a reduction in cross-sectional area of the flow passage is suppressed.

A guide part 304 shown in FIG. 12C may be installed on the second pipe 32R in place of the guide part 301. The guide part 304 protrudes toward the inside of the first pipe 31R from the opening at a terminal end of the second pipe 32R in a state where the guide part 304 is inclined so as to guide recirculated air toward the upstream side of temperature adjusted air. Also with this guide part 304, the flow of recirculated air can be deflected toward the upstream side of temperature adjusted air so that it is possible to cause a merging angle θ (FIG. 12A), formed by the flow of recirculated air and the flow of temperature adjusted air, to approximate to a right angle, or be set to the right angle or less. Accordingly, mixing can be promoted.

Besides the above, the configuration described in the above-mentioned embodiment may be selectively used, or may be appropriately changed to another configuration without departing from the gist of the present invention.

It is not indispensable that the premixing zone 34R extends with a predetermined length from the merging position 33R to the inlet 10R of the mixing chamber 3. Even in the case where a distance from the merging position 33R to the inlet 10R is close to zero, a constitutional element for promoting mixing, such as the flow passage restricting part 35 in the first embodiment or the guide part 301 in the second embodiment, is disposed in the vicinity of the merging position 33R and hence, it is possible to obtain an effect of promoting mixing of temperature adjusted air and recirculated air.

What is claimed is:

1. An air conditioning piping structure for an aircraft which causes temperature adjusted air obtained by an air conditioning apparatus of the aircraft and recirculated air discharged from an air-conditioned compartment to flow into a mixing chamber which mixes the temperature adjusted air and the recirculated air, wherein the piping structure comprises:
a first pipe through which the temperature adjusted air flows;
a second pipe through which the recirculated air flows, and which is connected to the first pipe; and
a flow passage restricting part configured to apply a resistance to at least one of the temperature adjusted air and the recirculated air at a position in a vicinity of a merging position where the temperature adjusted air and the recirculated air are merged.

2. An air conditioning piping structure for an aircraft which causes temperature adjusted air obtained by an air conditioning apparatus of the aircraft and recirculated air discharged from an air-conditioned compartment to flow into a mixing chamber which mixes the temperature adjusted air and the recirculated air, wherein the piping structure comprises:
a first pipe through which the temperature adjusted air flows;
a second pipe through which the recirculated air flows, and which is connected to the first pipe; and
a flow passage restricting part configured to apply a resistance to a merged flow of the temperature adjusted air and the recirculated air.

3. The air conditioning piping structure for an aircraft according to claim 2, wherein
a cross-sectional area of a flow passage at a position downstream of a merging position where the temperature adjusted air and the recirculated air are merged and in a vicinity of the merging position is reduced by the flow passage restricting part, and
the flow passage restricting part is positioned at least on the second pipe side in cross section of the flow passage.

4. The air conditioning piping structure for an aircraft according to claim 1, wherein
the flow passage restricting part is formed into an annular shape or a cylindrical shape along a circumferential direction of a cross section of a flow passage at a position in the vicinity of the merging position where the temperature adjusted air and the recirculated air are merged or downstream of the merging position.

5. The air conditioning piping structure for an aircraft according to claim 1, comprising:
a right first pipe forming the first pipe through which the temperature adjusted air obtained by an air conditioning apparatus which corresponds to a starboard side flows;
a right second pipe forming the second pipe through which the recirculated air flows toward a position where the recirculated air is merged with the temperature adjusted air flowing through the right first pipe;
a left first pipe forming the first pipe through which the temperature adjusted air obtained by an air conditioning apparatus which corresponds to a port side flows; and
a left second pipe forming the second pipe through which the recirculated air flows toward a position where the recirculated air is merged with the temperature adjusted air flowing through the left first pipe, wherein
the mixing chamber includes:
a right inlet which causes the temperature adjusted air and the recirculated air which respectively flow through the right first pipe and the right second pipe and are merged to flow into the mixing chamber; and
a left inlet which causes the temperature adjusted air and the recirculated air which respectively flow through the left first pipe and the left second pipe and are merged to flow into the mixing chamber from a side opposite to the right inlet, and
the flow passage restricting part is configured to apply a resistance to at least one of merging of the temperature adjusted air and the recirculated air on the right side and merging of the temperature adjusted air and the recirculated air on the left side.

6. An air conditioning piping structure for an aircraft which causes temperature adjusted air obtained by an air conditioning apparatus of the aircraft and recirculated air discharged from an air-conditioned compartment to flow into a mixing chamber which mixes the temperature adjusted air and the recirculated air, wherein the piping structure comprises:
a first pipe through which the temperature adjusted air flows;
a second pipe through which the recirculated air flows, and which is connected to the first pipe; and
a guide part configured to guide the recirculated air toward an upstream side of the temperature adjusted air flowing through the first pipe.

7. The air conditioning piping structure for an aircraft according to claim 6, wherein
at a position where the temperature adjusted air and the recirculated air are merged,
an angle formed by a flow of the temperature adjusted air and a flow of the recirculated air is an acute angle or a right angle.

8. The air conditioning piping structure for an aircraft according to claim 6, wherein
the second pipe is formed into a shape which includes the guide part.

9. The air conditioning piping structure for an aircraft according to claim 6, comprising:
a right first pipe forming the first pipe through which the temperature adjusted air obtained by an air conditioning apparatus which corresponds to a starboard side flows;
a right second pipe forming the second pipe through which the recirculated air flows toward a position where the recirculated air is merged with the temperature adjusted air flowing through the right first pipe;
a left first pipe forming the first pipe through which the temperature adjusted air obtained by an air conditioning apparatus which corresponds to a port side flows; and
a left second pipe forming the second pipe through which the recirculated air flows toward a position where the recirculated air is merged with the temperature adjusted air flowing through the left first pipe, wherein
the mixing chamber includes:
a right inlet which causes the temperature adjusted air and the recirculated air which respectively flow through the right first pipe and the right second pipe and are merged to flow into the mixing chamber; and
a left inlet which causes the temperature adjusted air and the recirculated air which respectively flow through the left first pipe and the left second pipe and are merged to flow into the mixing chamber from a side opposite to the right inlet, and
the guide part is provided with respect to at least one of merging of the temperature adjusted air and the recirculated air on the right side and merging of the temperature adjusted air and the recirculated air on the left side.

10. The air conditioning piping structure for an aircraft according to claim 1, comprising
a premixing zone where the temperature adjusted air and the recirculated air are merged, and flow into the mixing chamber.

11. The air conditioning piping structure for an aircraft according to claim 10, wherein
the premixing zone extends along an axis of the first pipe.

12. The air conditioning piping structure for an aircraft according to claim 1, comprising the mixing chamber.

13. The air conditioning piping structure for an aircraft according to claim 1, comprising:
a right first pipe forming the first pipe through which the temperature adjusted air obtained by an air conditioning apparatus which corresponds to a starboard side flows;
a right second pipe forming the second pipe through which the recirculated air flows toward a position where the recirculated air is merged with the temperature adjusted air flowing through the right first pipe;
a left first pipe forming the first pipe through which the temperature adjusted air obtained by an air conditioning apparatus which corresponds to a port side flows; and
a left second pipe forming the second pipe through which the recirculated air flows toward a position where the recirculated air is merged with the temperature adjusted air flowing through the left first pipe, wherein
the mixing chamber includes:
a right inlet which causes the temperature adjusted air and the recirculated air which respectively flow through the right first pipe and the right second pipe and are merged to flow into the mixing chamber;
a left inlet which causes the temperature adjusted air and the recirculated air which respectively flow through the left first pipe and the left second pipe and are merged to flow into the mixing chamber from a side opposite to the right inlet;
a right premixing zone which extends to the right inlet from a position where the temperature adjusted air and the recirculated air which respectively flow through the right first pipe and the right second pipe are merged; and
a left premixing zone which extends to the left inlet from a position where the temperature adjusted air and the recirculated air which respectively flow through the left first pipe and the left second pipe are merged, and
a length of the right premixing zone and a length of the left premixing zone differ from each other.

14. An air conditioning system for an aircraft, wherein the air conditioning system comprises:
the air conditioning piping structure according to claim 1;
the air conditioning apparatus configured to obtain the temperature adjusted air using bleed air and outside air;
a supply system configured to supply conditioned air which passes through the mixing chamber to the air-conditioned compartment; and
a recirculation system where the recirculated air discharged from the air-conditioned compartment flows.

15. An air conditioning system for an aircraft, wherein the air conditioning system comprises:
the air conditioning piping structure according to claim 2;
the air conditioning apparatus configured to obtain the temperature adjusted air using bleed air and outside air;
a supply system configured to supply conditioned air which passes through the mixing chamber to the air-conditioned compartment; and
a recirculation system where the recirculated air discharged from the air-conditioned compartment flows.

16. An air conditioning system for an aircraft, wherein the air conditioning system comprises:
the air conditioning piping structure according to claim 6;
the air conditioning apparatus configured to obtain the temperature adjusted air using bleed air and outside air;
a supply system configured to supply conditioned air which passes through the mixing chamber to the air-conditioned compartment; and
a recirculation system where the recirculated air discharged from the air-conditioned compartment flows.

17. The air conditioning piping structure for an aircraft according to claim 2, wherein
the flow passage restricting part is formed into an annular shape or a cylindrical shape along a circumferential direction of a cross section of a flow passage at a position in the vicinity of the merging position where the temperature adjusted air and the recirculated air are merged or downstream of the merging position.

18. The air conditioning piping structure for an aircraft according to claim 2, comprising:
a right first pipe forming the first pipe through which the temperature adjusted air obtained by an air conditioning apparatus which corresponds to a starboard side flows;
a right second pipe forming the second pipe through which the recirculated air flows toward a position where the recirculated air is merged with the temperature adjusted air flowing through the right first pipe;
a left first pipe forming the first pipe through which the temperature adjusted air obtained by an air conditioning apparatus which corresponds to a port side flows; and
a left second pipe forming the second pipe through which the recirculated air flows toward a position where the recirculated air is merged with the temperature adjusted air flowing through the left first pipe, wherein
the mixing chamber includes:
a right inlet which causes the temperature adjusted air and the recirculated air which respectively flow through the right first pipe and the right second pipe and are merged to flow into the mixing chamber; and
a left inlet which causes the temperature adjusted air and the recirculated air which respectively flow through the left first pipe and the left second pipe and are merged to flow into the mixing chamber from a side opposite to the right inlet, and
the flow passage restricting part is provided with respect to at least one of merging of the temperature adjusted air and the recirculated air on the right side and merging of the temperature adjusted air and the recirculated air on the left side.
